(19) United States
(12) Patent Application Publication
(10) Pub. No.: US 2017/0126097 A1
(43) Pub. Date: May 4, 2017

(54) ELECTRICAL GENERATION SYSTEM

(71) Applicant: Gregory R. Potter, Courtice (CA)

(72) Inventor: Gregory R. Potter, Courtice (CA)

(21) Appl. No.: 14/925,245

(22) Filed: Oct. 28, 2015

(51) Int. Cl. H02K 7/18

(52) U.S. Cl. CPC H02K 7/1823; Y10S 415/916; F03B 17/005

(57) ABSTRACT

An electrical generation system is disclosed. The electrical generation system includes a motor coupled to a permanent magnet generator and a liquid pump coupled to a liquid source to provide a pressurized stream of liquid that impinges upon a water turbine that is coupled to a second generator. An initial power supply provides the power to start operation after which output from the generators is used to power the motors and liquid pump to sustain operation. Power from the generators is rectified and then converted back to alternating current by a power inverter.

### FIELD

The present disclosure relates generally to a system for generating electricity. More particularly, the present disclosure relates to portable systems for generating electricity.

### BACKGROUND

Electrical generators are generally expensive to obtain, maintain and operate. Generators typically are inefficient and consume large amounts of fossil fuels to create low levels of electricity. Often, they include a gasoline motor for powering the generator to produce electricity. The gasoline motor pollutes the environment. The motor is often very noisy. The noise may force the generator to be positioned a long distance from where the electricity will be used. This distance adds to the inefficiency of operation of the generator. Therefore, a need exists for a portable electrical generator which is quiet and efficient, with minimal impact on the environment.

### SUMMARY

According to a first aspect, an electrical generation system is provided that comprises a motor having a rotor coupled to drive a permanent magnet generator, a liquid pump coupled to a liquid source to provide a pressurized stream of liquid that impinges upon a water turbine coupled to a second generator, at least two rectifiers, each of the rectifiers coupled to a corresponding one of the permanent magnet generator and the second generator to provide a DC power output, a power inverter coupled to the DC power output of each of the at least two rectifiers to provide an output power supply, and wherein the power inverter is coupled to the motor and the liquid pump for continuous operation of the system, and an initial power supply coupled to any one of the motor and liquid pump to provide initial power until the power inverter can sustain operation of the motor and liquid pump. The output power supply can be an alternating current having a standardized voltage and frequency. For example, the standardized voltage can be between 110 and 600 volts and the frequency can be between 50 Hertz and 60 Hertz.

The initial power supply of the electrical generation system can be coupled to a control unit that determines when to cut-off the initial power supply from powering any one of motor, liquid pump, or both motor and liquid pump. The control unit can include an on-delay timer that cuts off the initial power supply after a fixed period of time. The control unit can also include an automatic transfer switch that cuts off the initial power supply. The initial power supply can be a battery, such as a gel lead-acid battery, and the system can also include a battery charger coupled to the power inverter to allow the battery to recharge the battery. The battery charger can also be integrated with the power inverter. The initial power supply can provide direct current power to any one of the motor and liquid pump. The power inverter can be a pure sine wave inverter or a modified sine wave inverter. The initial power supply can be coupled to the power inverter to provide alternating current power to any one of the motor and liquid pump. A modified sine wave inverter is preferred for embodiments using AC motors.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a block diagram of an electrical generation system;

FIG. 2. is a block diagram of an embodiment of the electrical generation system of FIG. 1 having direct current (DC) motors and liquid pumps;

FIG. 3. is a block diagram of an embodiment of the electrical generation system of FIG. 1 having alternating current (AC) motors and liquid pumps;

FIG. 4 is a perspective view of a portable housing for containing an embodiment of the electrical generation system of FIG. 1; and

FIG. 5 is a top view of the portable housing of FIG. 4 containing an embodiment of the electrical generation system of FIG. 1.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments.

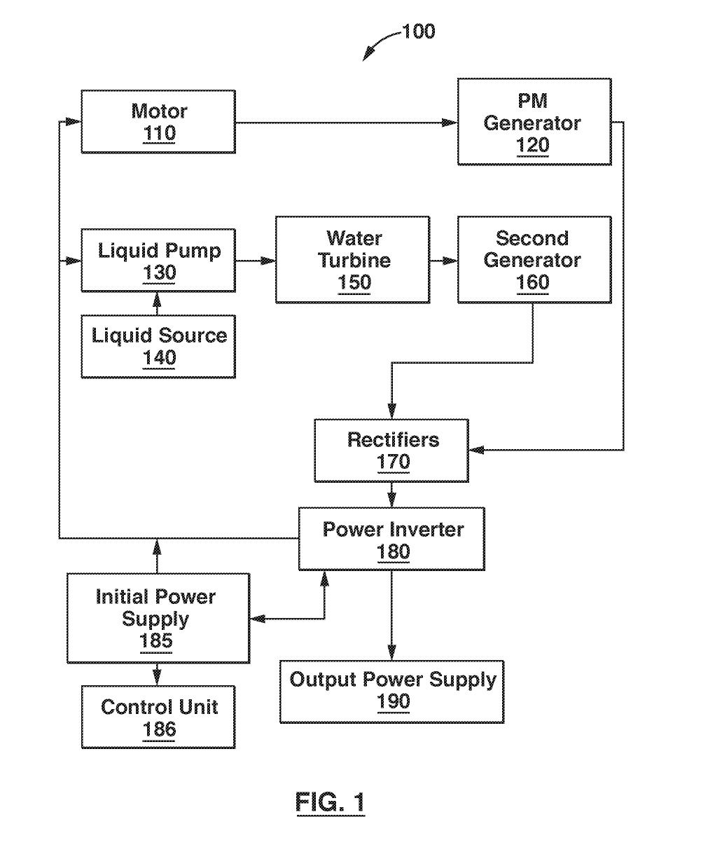

Reference will now be made to the drawings wherein like numerals refer to like parts throughout. Reference is first made to FIG. 1 which is a block diagram of an electrical generation system 100 that has an electric motor 110 that is driving a permanent magnet generator 120 and a liquid pump 130 that drives a second generator 160 through a water turbine 150. Permanent magnet generator 120 has high efficiency when operating at low revolutions per minute. Liquid pump 130 is coupled to a liquid source 140 to provide a pressurized stream of liquid that impinges upon water turbine 150 to drive second generator 160. Second generator 160 can also be a permanent magnet generator 160.

Permanent magnet generator 120 and second generator 160 produce an alternating current (AC) power output. This AC power output is typically in the form of low-voltage three phase power. Each of permanent magnet generator 120 and second generator 160 are coupled to a corresponding rectifier 170 to convert the AC power output from generators 120, 160 to a direct current (DC) power output. The DC power output of rectifiers 170 is coupled to a power inverter 180 that provides an output power supply 190, which is preferably a standardized mains general-purpose alternating current electric power supply, such as 120 V at a frequency of 60 Hz in North America or 230 V at a frequency of 50 Hz for other parts of the world. Output power supply 190 can have an output AC voltage anywhere between 110 and 600 volts. This allows electrical generation system 100 to power standard electrical appliances using common plugs. Output power supply 190 preferably includes one or more common sockets for accepting these common plugs, such as those plugs/sockets standardized by the National Electrical Manufacturers Association in North America.

Power inverter 180 is coupled to motor 110 and liquid pump 130 to provide power for continuous operation of the electrical generation system 100 after initial startup. Power produced by permanent magnet generator 120 and second generator 160 should be sufficient, after processing by rectifiers 170 and power inverter 180, to power motor 110 and liquid pump 130 as well as provide power to output power supply 190 to power electrical appliances.

Power inverter 180 is an electronic device that changes the direct current (DC) from rectifiers 170 to alternating current (AC). Preferably, power inverter 180 produces a multiple step sinusoidal AC waveform that produce less distortion, and is often referred to as a pure sine wave inverter. A pure sine wave inverter is more complex and has a higher cost but provides an output with much less distortion. A sine wave output is desirable because many electrical products are engineered to work best with a sine wave AC power source. In some embodiments, power inverter 180 can provide 3000 watts of continuous power and 9000 watts of peak power at 25 amps from a DC input voltage between 10.5 to 15 volts. Power inverter 180 can also be a modified sine wave inverter that approximates a pure sine waveform but are less expensive than pure sine wave inverters. Power inverter 180 should have a high efficiency.

Initial power supply 185 provides the initial power to motor 110 and/or liquid pump 130 to start the generation process. Electrical generation system 100 is started by powering either motor 110, liquid pump 130, or both motor 110 and liquid pump 130 to initiate power generation from corresponding permanent magnet generator 120 and/or second generator 160. After startup, power inverter 180 can provide sufficient power to motor 110 and liquid pump 130 to sustain operation of electrical generation system 100. Electrical generation system 100 can include an activation switch that couples initial power supply 185 to any of motor 110 and/or liquid pump 130 to start the generation process.

Initial power supply 185 can be coupled to electrical generation system 100 by a control unit 186. Control unit 186 can determine when initial power supply 185 is no longer required by either motor 110 or liquid pump 130 and cut off initial power supply 185 from powering either motor 110 or liquid pump 130. Control unit 186 can use an on-delay timer that cuts off initial power supply after a fixed period of time after starting electrical generation system 100. In some embodiments, control unit 186 can include an automatic transfer switch that cuts off initial power supply 185 after power inverter 180 is capable of providing sufficient output power to one or both of motor 100 and liquid pump 130 to sustain operation of electrical generation system 100.

Initial power supply 185 can be a battery, and more preferably, a rechargeable battery. In some embodiments, initial power supply 185 can be a lead-acid rechargeable batteries, such as a 12 volt gel cell valve-regulated lead-acid battery. Embodiments incorporating rechargeable batteries can further include a battery charger to recharge the batteries. The battery charger can be powered by an AC current provided by power inverter 180 or a DC current provided by rectifiers 170. In some embodiments the battery charger can be integrated with power inverter 180. Initial power supply 185 is preferably a battery to allow electrical generation system 100 to be portable.

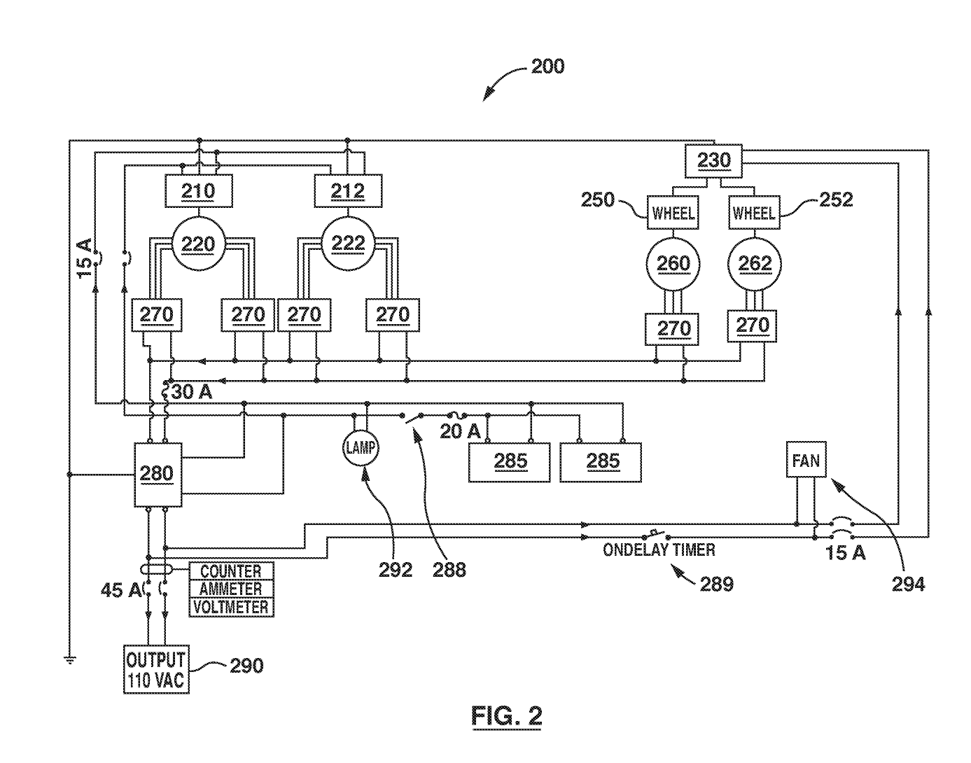

Motor 110 and liquid pump 130 can either be powered by AC power or DC power. In a DC powered embodiment, initial power supply 185 can be a DC source, such as a battery, that directly powers motor 110 and/or liquid pump 130. For example, a 12 volt DC battery can be used with a 12 volt DC powered liquid pump and motor. The 12 volt battery can then be constantly recharging to maintain DC power to motor 110 and liquid pump 130 using a battery charger or a battery charger that is integrated with power inverter 180. An embodiment using DC powered motors and pumps will be described in greater detail with respect to FIG. 2.

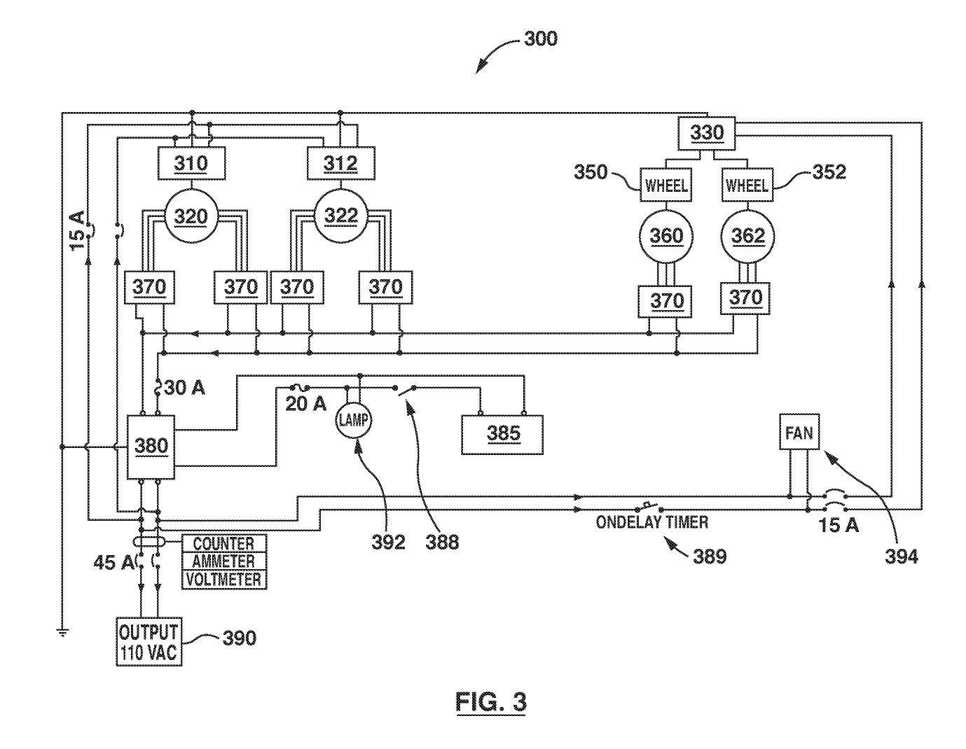

In an AC powered embodiments, motor 110 and liquid pump 130 are powered from the AC output of power inverter 180. Initial power supply 185 can provide DC power to power inverter 180 that in turn provides AC power to start motor 110 and liquid pump 130. An embodiment using AC powered motors and pumps will be described in greater detail with respect to FIG. 3.

Some embodiments can use different power sources for motor 110 and liquid pump 130. For example, motor 110 can be a DC powered motor that is powered by a battery and liquid pump 130 can be powered by AC power from power inverter 180, or vice versa, with an AC powered motor and DC powered pump. Initial power supply 185 can be coupled to either the motor 110 or liquid pump 130, and not both, so that the device coupled to initial power supply 185 provides sufficient power to start the other device.

In other embodiments of electrical generation system 100, initial power supply 185 can be provided by mechanical, hydraulic or electrical power sources other than a battery. These alternative sources may be preferable in non-portable embodiments. Mechanical sources can act directly to drive permanent magnet generator 120 using some type of clutch mechanism when the initial power supply is no longer required. Hydraulic (or moving liquid) initial power sources can act directly on water turbine 150 and be diverted when no longer required to sustain operation of electrical generation system 100.

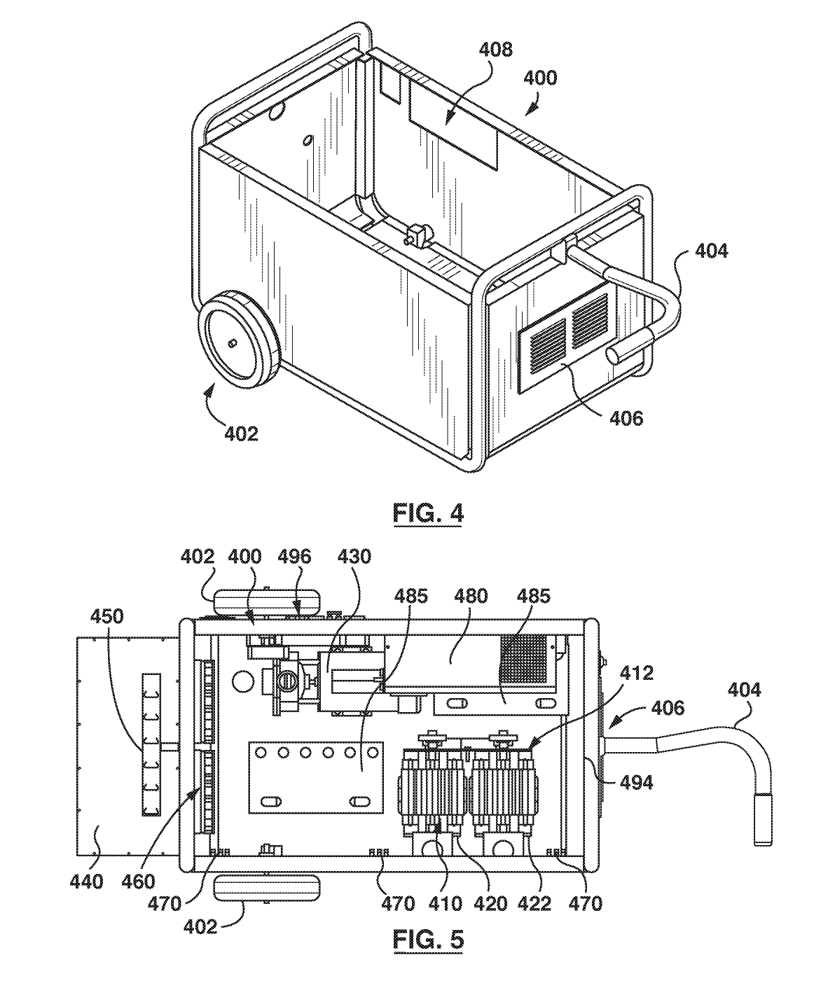

All components of electrical generation system 100 can be placed within, or attached to, a portable housing, such as, for example, portable housing 400 illustrated in FIG. 4. Liquid source 140 can be a storage tank that is attached to portable housing 400.

Portable housing 400 can further include a fan to create airflow within portable housing 400 to provide cooling air to the internal components.

Liquid pump 130, water turbine 150, and liquid source 140 are preferably in a sealed and closed system that reuses the same liquid from the storage tank. For example, water turbine 150 can be rotatably mounted within the storage tank above the level of the liquid, and liquid pump can pump water from the tank to a nozzle in the upper portion of the tank directed at water turbine 150. Preferably, the closed liquid system is designed to prevent loss of liquid (e.g. through evaporation) to reduce the operational and maintenance costs of electrical generation system 100. The liquid used is typically water but any liquid can be used. It is preferable to use a liquid having a low viscosity for efficiency of liquid pump 130 and a low volatility to limit evaporation.

Water turbine 150 is preferably an impulse type water turbine, such as a Pelton wheel-type turbine, that converts the energy of the pumped liquid from liquid pump 130 into mechanical energy to drive second generator 160. Water turbine 150 has impulse blades (or buckets) that are mounted around the circumferential rim of a drive wheel. A jet of liquid fluid driven by liquid pump 130 impinges upon the impulse blades exerting torque on water turbine 150.

Reference is now made to FIG. 2 which illustrates an embodiment of electrical generation system 200 where motors 210, 212 are powered by DC power and liquid pump 230 is powered by AC power. Motors 210, 212 are 12 volt DC motors that are powered by batteries 285 to provide initial startup of electrical generation system 200 upon closing of switch 288. Motors 210, 212 are coupled to permanent magnet generators 220, 222, respectively. The rotor of motors 210, 212 can be connected directly to the rotors or corresponding permanent magnet generators 220, 222, or through a mechanical gearing arrangement. The three-phase AC power produced by generators 220, 222 is rectified to DC power by corresponding rectifiers 270 that is then converted back to AC power by power inverter 280.

Output from power inverter 280 can provide a 110VAC output power. This output power can then also be used to power liquid pump 230. An on-delay timer 289 is used to delay providing power to liquid pump 230 until power inverter 280 can provide sufficient power output. Upon receiving power, liquid pump 230 then provides pressurized liquid streams that impinges on water turbines 250, 252 to drive the corresponding generators 260, 262. Water output from liquid pump 230 can be divided into two hoses to provide a high pressure stream to each water turbine 250, 252. Each generator 260, 262 can produce up to 2000 watts. The three-phase AC output power from generators 260, 262 is then rectified to DC power by corresponding rectifiers 270 that provide DC power to power inverter 280.

Electrical generation system 200 further includes a lamp 292 that indicates that the batteries 285 are in operation to initiate startup of the system. A fan 294 can be included to provide cooling to the components of electrical generation system 200, mainly generators, pumps and motors. Electrical generation system 200 can also include a counter, ammeter, and volt meter to measure the output of power inverter 280 to ensure that electrical generation system 200 is operating within parameters.

Reference is next made to FIG. 3 which illustrates an embodiment of electrical generation system 300 where motors 310, 312 and liquid pump 330 are all powered by AC power provided by power inverter 380. Similar reference numerals to FIG. 2 are used for similar components. Initial power supply 385, provided by a 12 volt battery, provides power to power inverter 380 which converts this to AC power to drive motors 310, 312. A modified sine wave inverter can be used to provide AC power to motor 310, 312 and/or liquid pump 330. After a period of time, motors 310, 312 can provide sufficient power to power inverter 380 to power liquid pump 330. On-delay timer 389 is used to couple the output to liquid pump 330 after a delay to allow power inverter 380 to generate sufficient power to power motors 310, 312 and liquid pump 230.

Example specifications will now be provided for components that can be used in electrical generation systems 200, 300 described with respect to FIGS. 2 and 3. These specifications are provided as examples only, and a skilled person may vary these specifications to obtain the desired results.

Example specifications for motors 210, 212: ¼ horsepower motors using a 12 volt DC input operating at 1800 RPM. AC motors have similar performance can be used for motors 310, 312.

Example specifications for permanent magnet generators 220, 222, 320, 322: Dual permanent magnet alternator design providing up to 2,800 watts output at 12 volts three-phase AC. Can be operated at an RPM between 133 to 960, or up to 1800 RPM.

Example specifications for rectifiers 270, 370: Three-phase rectifiers that produce a 12 volt DC output and output current between 10 to 300 amps. Input voltage can be between 100 to 1600 volts.

Example specifications for liquid pump 230, 330: 1 horsepower, two-speed pump operating on mains electricity (e.g. 120 volts AC at 60 Hz).

Example specifications for generators 260, 262, 360, 362: Operating at RPM between 140 to 2800 and producing an output of 200 to 4,000 watts three phase AC (120 VAC to 240VAC).

Example specification for inverter 280, 380: Can be a pure sine wave inverter for DC motor embodiments or a modified sine wave inverter for AC motor embodiments. Can include an integrated battery charger for charging battery 285, 385 (35-70 amp). Capable of producing 3000 watts continuous and 9000 watts peak power at 25 amps. Receives a 10.5 to 15 volt DC input.

Example specifications for battery 285, 385: 12 volt gel cell valve-regulated lead-acid battery with 102 Ah capacity.

Reference is now made to FIG. 4 which illustrates a perspective view of a portable housing 400 that can contain the components of an embodiment of electrical generation system 100. Preferably, portable housing has wheels 402 and a handle 404 to allow housing to be easily transported. Portable housing 400 can also include one or more intake vents 406. An internally mounted fan can be positioned near intake vents to draw outside air into portable housing 400. Portable housing 400 can also be configured as a trailer that can be towed by a vehicle, such as by including a tow hitch.

Reference is now made to FIG. 5 which provides a top view of portable housing 400 illustrating an example layout of the internal components of electrical generation system 100. Motors 410, 412 can be mounted above and adjacent to permanent magnet generators 420, 422 and their rotors coupled via a belt. Rectifiers 470 can be mounted on the interior wall of portable housing 400. Batteries 485 are mounted on the floor of portable housing 400 due to their weight. Liquid tank 440 can be mounted to the end of portable housing 400 and water turbine 450 can be rotatably mounted therein and coupled to generator 460 mounted within portable housing 400. Liquid pump 430 can be coupled to the liquid tank 440 via tubing to obtain liquid for directing towards water turbine 450.

An instrument panel 496 can be mounted in a cut-out portion 408 of side-wall of portable housing 400. Instrument panel 496 can provides lights, switches, and displays for operating the electrical generation system 100. Fan 494 can be mounted near intake vent 406.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. An electrical generation system, the system comprising:
a motor having a rotor coupled to drive a permanent magnet generator;
a liquid pump coupled to a liquid source to provide a pressurized stream of liquid that impinges upon a water turbine coupled to a second generator;
at least two rectifiers, each of the rectifiers coupled to a corresponding one of the permanent magnet generator and the second generator to provide a DC power output;
a power inverter coupled to the DC power output of each of the at least two rectifiers to provide an output power supply, and wherein the power inverter is coupled to the motor and the liquid pump for continuous operation of the system; and
an initial power supply coupled to any one of the motor and liquid pump to provide initial power until the power inverter can sustain operation of the motor and liquid pump.

2. The electrical generation system of claim 1 wherein the output power supply is an alternating current having a standardized voltage and frequency.

3. The electrical generation system of claim 2 wherein the standardized voltage is between 110 and 600 volts and the frequency is between 50 Hertz and 60 Hertz.

4. The electrical generation system of claim 1 wherein the initial power supply is coupled to a control unit wherein the control unit determines when to cut-off the initial power supply from powering any one of motor, liquid pump, or both motor and liquid pump.

5. The electrical generation system of claim 4 wherein the control unit comprises an on-delay timer that cuts off the initial power supply after a fixed period of time.

6. The electrical generation system of claim 5 wherein the control unit comprises an automatic transfer switch that cuts off the initial power supply.

7. The electrical generation system of claim 4 wherein the initial power supply is a battery.

8. The electrical generation system of claim 1 further comprising a battery charger coupled to the power inverter and the battery to recharge the battery.

9. The electrical generation system of claim 7 wherein the battery charger is integrated with the power inverter.

10. The electrical generation system of claim 1 further comprising a portable housing.

11. The electrical generation system of claim 1 wherein the power inverter is any one of a pure sine wave inverter and a modified sine wave inverter.

12. The electrical generation system of claim 1 wherein the liquid source is a liquid tank.

13. The electrical generation system of claim 9 wherein the liquid is water.

14. The electrical generation system of claim 1 wherein initial power supply provides direct current power to any one of the motor and liquid pump.

15. The electrical generation system of claim 1 wherein initial power supply is coupled to the power inverter to provide alternating current power to any one of the motor and liquid pump.
